(19) United States
(12) Patent Application Publication
(10) Pub. No.: US 2018/0242344 A1
(43) Pub. Date: Aug. 23, 2018

(54) Spatial-time fair scheduling for SU and MU transmission based on physical layer capabilities

(71) Applicant: QUALCOMM Incorporated, San Diego, CA (US)

(72) Inventors: Xiaolong Huang, San Jose, CA (US); Madhan Jaganathan, Cupertino, CA (US); Nathaniel David Houghton, San Jose, CA (US); Madhavan Nair, Sunnyvale, CA (US); Srinivas Katar, Fremont, CA (US); Ahmed Ragab Elsherif, San Jose, CA (US)

(21) Appl. No.: 15/932,209

(22) Filed: Feb. 16, 2018

Related U.S. Application Data
(60) Provisional application No. 62/460,486, filed on Feb. 17, 2017.

(51) Int. Cl. H04W 72/12; H04W 72/04

(52) U.S. Cl. CPC H04W 72/1257; H04W 72/04

(57) ABSTRACT

A method, an apparatus, and a computer-readable medium for wireless communication are provided. In one aspect, an apparatus may be configured to determine a scheduling metric for each respective station of a plurality of stations. The scheduling metric for each station may be based on an effective spatial-time-frequency physical layer (PHY) capability for the station and a consumption rate of spatial-time-frequency resources by the respective station. The effective spatial-time-frequency PHY capability for the station may be a product of a target percentage of spatial-time resources allocated to the station, an effective number of spatial streams supported by the respective station, and a maximum bandwidth. The consumption rate of spatial-time-frequency resources may be a transmit opportunity (TXOP) moving average of consumption rate by the station. The apparatus may be configured to schedule each station of the plurality of stations for communication based on the determined scheduling metric for each respective station.

### CROSS-REFERENCE TO RELATED APPLICATION(S)

This application claims the priority benefit of U.S. Provisional Application Ser. No. 62/460,486, entitled “SPATIAL-TIME FAIR SCHEDULING FOR SU AND MU TRANSMISSION BASED ON PHYSICAL LAYER CAPABILITIES” and filed on Feb. 17, 2017, which is expressly incorporated by reference herein in its entirely.

### BACKGROUND

### Field

The present disclosure relates generally to communication systems, and more particularly, to spatial-time fair scheduling for single user (SU) and multi user (MU) transmissions based on physical layer capabilities of devices.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable media, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

Various aspects related to fair scheduling of airtime resources by an access point (AP) among devices with different multi-user (MU) capabilities and devices with single-user (SU) capabilities of a multi-user multiple-input multiple-output (MIMO) system is described. In a multi-user MIMO (MU-MIMO) system, the AP may use beamforming to transmit its MIMO spatial streams of data through multiple antennas to multiple users and/or devices simultaneously. Devices may have multiple antennas to receive multiple spatial streams to support a single user (SU) or multiple users (MU). MU capable devices may have different number of antennas to support different number of spatial streams and may operate in different operating modes such as selectively operating in SU or MU mode. The AP may schedule airtime resources among devices with mixed physical layer (PHY) capabilities and mixed operating modes to preserve fairness among the devices. The present disclosure provides scheduling techniques for mixed MU/SU devices so that the airtime for SU devices (MU incapable devices) may be preserved regardless of the operating modes of MU capable devices. The techniques also preserve the higher throughput capability of MU capable devices that support a higher number of spatial streams when scheduling airtime.

One aspect of this disclosure provides a method for wireless communication. The method includes determining a scheduling metric for each respective station of a plurality of stations. The scheduling metric for each respective station of the plurality of stations may be based on an effective spatial-time-frequency physical layer (PHY) capability for the respective station and a consumption rate of spatial-time-frequency resources by the respective station. The method further includes scheduling each respective station of the plurality of stations for communication based on the determined scheduling metric for each respective station.

Another aspect of this disclosure provides an apparatus (e.g., a wireless device such as an access point or a station) for wireless communication. The apparatus includes a memory and at least one processor coupled to the memory. The processor may be configured to determine a scheduling metric for each respective station of a plurality of stations. The scheduling metric for each respective station of the plurality of stations may be based on an effective spatial-time-frequency physical layer (PHY) capability for the respective station and a consumption rate of spatial-time-frequency resources by the respective station. The processor may be further configured to schedule each respective station of the plurality of stations for communication based on the determined scheduling metric for each respective station.

Another aspect of this disclosure provides an apparatus for wireless communication. The apparatus includes means for determining a scheduling metric for each respective station of a plurality of stations. The scheduling metric for each respective station of the plurality of stations may be based on an effective spatial-time-frequency physical layer (PHY) capability for the respective station and a consumption rate of spatial-time-frequency resources by the respective station. The apparatus further includes means for scheduling each respective station of the plurality of stations for communication based on the determined scheduling metric for each respective station.

Another aspect of this disclosure provides a non-transitory computer-readable medium for storing computer executable code. The code may be executed by a processor to determine a scheduling metric for each respective station of a plurality of stations. The scheduling metric for each respective station of the plurality of stations may be based on an effective spatial-time-frequency physical layer (PHY) capability for the respective station and a consumption rate of spatial-time-frequency resources by the respective station. The code may be further executed by the processor to schedule each respective station of the plurality of stations for communication based on the determined scheduling metric for each respective station.

### BRIEF DESCRIPTION OF THE DRAWINGS

FIG. 1 shows an example wireless communication system in which aspects of the present disclosure may be employed.

FIG. 2 is a diagram of a method for performing spatial-time fair scheduling.

FIG. 3A is a diagram of a first setup for spatial-time fair scheduling among SU and MU capable STAs.

FIG. 3B is a diagram of a second setup for spatial-time fair scheduling among SU and MU capable STAs.

FIG. 3C is a diagram of a third setup for spatial-time fair scheduling among SU and MU capable STAs.

FIG. 3D is a diagram of a fourth setup for spatial-time fair scheduling among SU and MU capable STAs.

FIG. 4 shows an example functional block diagram of a wireless device that determines a number of transmit chains to use for packet transmission within the wireless communication system of FIG. 1.

FIG. 5 is a flowchart of an example method of scheduling stations based on a scheduling metric.

FIG. 6 is a functional block diagram of an example wireless communication device that may determine a scheduling metric based on physical capabilities.

### DETAILED DESCRIPTION

Various aspects of the novel systems, apparatuses, computer-readable media, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP.

As discussed, the various aspects described herein may apply to any communication standard or wireless protocol. For example, in cellular communication (e.g., LTE), an access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A station may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, a station may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

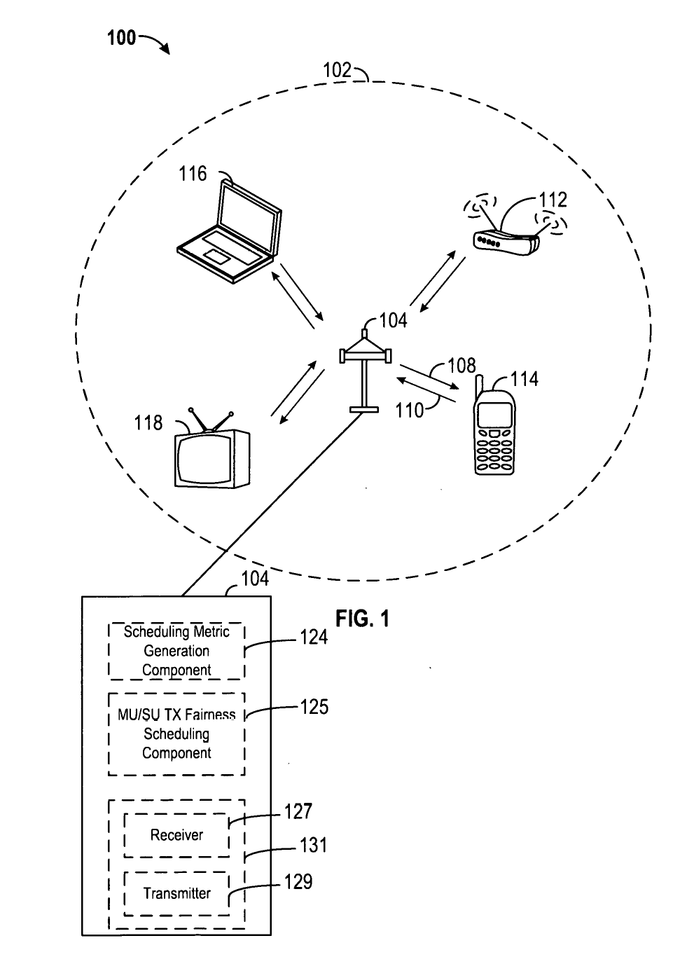

FIG. 1 shows an example wireless communication system 100 in which aspects of the present disclosure may be employed. The wireless communication system 100 may operate pursuant to a wireless standard, such as an 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may be required to associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, the STA 114 may transmit a reference signal, such as an association probe or request, to the AP 104. In some aspects, the AP 104 may use backhaul services, for example, to communicate with a larger network, such as the Internet or a public switched telephone network (PSTN).

The AP 104 may be a multiple-input multiple-output (MIMO) system that has multiple antennas. Each antenna may transmit or receive a spatial stream of data. To support greater data rate at greater distance, the MIMO system may use a beamforming technique that focuses the transmit energy of one or more MIMO spatial streams toward the direction of a target STA by introducing differences in the phase and amplitude of the transmission from the antennas. In multi-user MIMO (MU-MIMO) technology, the AP 104 may transmit its MIMO spatial streams to multiple users and/or STAs simultaneously. For example, the AP 104 may have four antennas. Using beamforming, the AP 104 may establish four simultaneous links to STAs 112, 114, 116, and 118 by steering the spatial stream from each antenna toward the direction of a respective target STA. One or more of the STAs 112, 114, 116, and 118 may also have multiple antennas to form a beamforming pattern to receive multiple spatial streams from, or to transmit multiple spatial streams to, the AP 104. A STA may have the capability to support multiple users (MU) or a single user (SU). For example, the STA 114 may have two antennas to receive two spatial streams to support two users, one spatial stream per user. The STA 114 may selectively turn off its MU capability so that both spatial streams are used to support SU. In another example, the STA 114 may receive multiple spatial streams, but is capable of supporting SU only (i.e., MU incapable STA).

In the MU-MIMO system, the AP 104 may communicate with STAs of mixed physical layer (PHY) capabilities and operating modes (e.g., MU capable/MU incapable STAs, MU capable STAs operating in MU/SU mode, different number of antennas and different number of spatial streams). The STAs may have different traffic profiles, quality of service (QoS) requirements, and may experience different channel conditions. The AP 104 may allocate the spatial-timing-frequency resources of the channel and may assign transmit opportunity (TXOP) to each STA to provide contention free access to the channel for each STA.

In an aspect, the AP 104 may include one or more components for performing various functions. One function may be to schedule MU and SU transmissions (TX) to the STAs according to the channel conditions, PHY capabilities, user traffic profiles, QoS requirements, fairness consideration among the STAs, etc. For example, the AP 104 may include a scheduling metric generation component 124 and a MU/SU TX fairness scheduling component 125 to perform procedures related to spatial-time scheduling. The AP 104 may include a receiver 127 and a transmitter 129. The receiver 127 may be configured to perform any receiving function described herein. The transmitter 129 may be configured to perform any transmitting function described herein. The receiver 127 and the transmitter 129 may be combined into a transceiver 131.

The scheduling metric generation component 124 may be configured to determine a scheduling metric for each STA of a plurality of STAs. The scheduling metric for a STA may be determined based on a target percentage of spatial-time resources allocated for the STA, an effective number of spatial streams supported by the STA, a maximum bandwidth, and a TXOP moving average consumption rate of the STA. The target percentage of spatial-time resources allocated for the STA may be based on the QoS requirement of the STA. In one aspect, the target percentage of spatial-time resources may include spectral resources such as frequency channels or subcarriers. The effective number of spatial streams supported by the STA may take into account the PHY capability such as the transmit/receive (TX/RX) capability of the STA under its current channel condition. The TXOP moving average consumption rate of the STA measures the traffic profile by determining the spatial-timing-frequency resources of the channel consumed by the STA in a moving window of interest.

The MU/SU TX fairness scheduling component 125 may be configured to schedule each STA of the plurality of STAs for communication based on the determined scheduling metric for each STA. For example, the MU/SU TX fairness scheduling component 125 may sort the scheduling metrics for all the STAs to determine the order by which TXOPs are assigned to the STAs. In one aspect, STAs associated with the higher scheduling metrics are assigned TXOPs first in descending priority until each STA has been assigned or the all the TXOPs have been assigned. The TXOP for a STA contains the spatial-timing-frequency resources to be used by the STA for communicating with the AP 104. The TXOP may be assigned for DL, UL, or both DL and UL directions by the STA. At periodic intervals, the AP 104 may recompute the TXOP moving average consumption rate and the scheduling metric for each STA to reassign the TXOPs among the STAs based on changing traffic profiles and channel conditions.

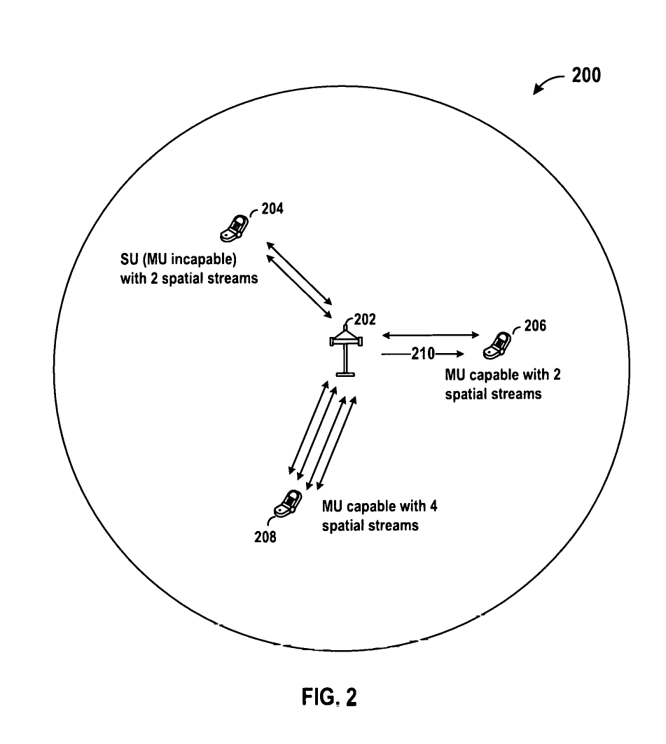

FIG. 2 is a diagram 200 of a method for performing spatial-time fair scheduling. In a wireless communication network (e.g., a Wi-Fi network), an AP 202 may be associated with STAs 204, 206, 208 or any other number of STAs. The AP 202 may serve STAs with different PHY capabilities at the same time. For example, some STAs may be MU capable while other STAs may not be MU capable (only SU capable). In another example, some MU capable STAs may support a greater number of spatial streams than other MU capable STAs. In an aspect, however, MU capable STAs, especially those that support a large number of spatial streams, may occupy more than their fair share of TXOP. To avoid starving MU incapable STAs of airtime, a network (e.g., AP 202) may determine how to schedule STAs based upon their PHY capabilities while preserving fairness among STAs with different capabilities. In one aspect, the airtime of a STA refers to the TXOP allocated to the STA. In one aspect, the TXOP may include the spatial-time-frequency resources to be used by the STA for communicating with the AP 104 for DL and/or UL. For example, the airtime of MU incapable STAs may be preserved and kept consistent regardless of whether MU capable STAs enable their MU capabilities. In one aspect, the allocation of airtime to MU incapable STAs may be determined independent of the number of spatial streams supported by the MU incapable STAs. Furthermore, MU capable STAs that support a higher number of spatial streams may be provided proportionately more TXOPs such that the MU capable STAs may achieve higher throughput that is proportionate to their achievable number of spatial streams. In one aspect, the achievable number of spatial streams for MU capable STAs may take into account the current channel condition so that TXOPs are not wasted under a channel condition that does not support the higher throughput that is otherwise achievable given the number of spatial streams. By preserving the airtime of MU incapable STAs independent of the operating mode of the MU capable STAs, the MU incapable STAs are not disadvantaged when the MU capable STAs turn on the MU capability to support more users. On the other hand, by providing proportionately more airtime to MU capable STAs with more spatial streams, MU capable STAs with higher capability may be leveraged to support higher throughput.

Referring to FIG. 2, the STA 204 may be MU incapable and the STAs 206, 208 may be MU capable. The STAs 204, 206 may support 2 spatial streams, and the STA 208 may support 4 spatial streams. The AP 202 may utilize a scheduler routine in which the AP 202 fairly serves the STAs 204, 206, 208 with different physical capabilities at the same time. The AP 202 may schedule the STAs based on a statistical record that reflects each STA's recent airtime consumption rate in comparison to the STA's PHY capability, such as the number of spatial streams, bandwidth, and MU capabilities, if any. The STA's PHY capability may take into account the channel condition experienced by the STA. For example, even though the MU capable STA 208 may have 4 spatial streams to support up to 4 users, if the STA 208 is located at the fringe of the coverage area of the AP 202, the PHY capability may be capable of supporting only a single user. In an aspect, the airtime consumption rate may consider the fraction of spatial-time-frequency resources that the STA occupies in recent transmissions or reception when the STA joins an MU transmissions. For example, if a STA joined a transmission in which three users transmit simultaneously using equal spatial-time-frequency resources, then the fraction of spatial-time-frequency resources occupied by each STA is one third. In one aspect, the airtime consumption rate may be a moving average of the airtime consumption rate in a window of interest. In one aspect, the moving average may be a weighted average that gives more weight to the more recent air consumption rate in the moving window.

In one configuration, the AP 202 may schedule each of the STAs 204, 206, 208 by determining a scheduling metric for each STA. The scheduling metric may be determined according to Eq. 1:

$$scheduling metric = {Φ}_{i} \frac{{NSS}_{i}^{E} \cdot {BW}_{i}^{C}}{{R}_{i}^{TXOP}} \qquad ( Eq . 1 )$$

Referring to Eq. 1, the scheduling metric compares each STA's recent airtime consumption rate in comparison to the STA's target consumption, a maximum bandwidth, and the STA's PHY capability, such as the number of spatial streams, and MU capabilities, if any. Φᵢ denotes the spatial-time percentage that STA i is targeted to have among all STAs. In one aspect, Φᵢ may denote the spatial-time-frequency percentage that STA i is targeted to have among all STAs. A higher spatial-time percentage corresponds to a greater amount of airtime, whereas a smaller spatial-time percentage corresponds to a lesser amount of airtime. In one aspect, Φᵢ may represent the percentage of airtime that STA i is targeted to have assuming the capabilities of all the STAs are the same. In one aspect, φᵢ may take into consideration the QoS requirement of the STA i. NSSᵢ^{E} denotes an effective number of spatial streams supported by STA i and may be computed according to Eq. 2:

$${NSS}_{i}^{E} = \{ \begin{matrix}{NSS}_{i}^{C} , & M U capable STA \\ {NSS}^{const} , & M U incapable STA\end{matrix} \qquad ( Eq . 2 )$$

Referring to Eq. 2, in one aspect, when STA i is MU capable (e.g., STA 206 or STA 208), NSSᵢ^{E} for STA i is equal to NSSᵢ^{C}, the maximum number of spatial streams that an MU capable STA i may support under current channel conditions with a particular physical transmit and receive capability. NSSᵢ^{C} may be independent of whether the MU capability of STA i is turned on or off because it is a function of the maximum number of spatial streams supported, not the number of users supported. However, NSSᵢ^{C} may be a function of the channel conditions because the effective number of spatial streams supported by a STA may be less than the maximum number of spatial streams if the channel conditions are not favorable and data throughput needs to be reduced. In another aspect, when STA i is MU incapable (e.g., the STA 204), NSSᵢ^{E} for STA i is equal to NSS^{const}, which denotes a constant number of spatial streams associated with all MU incapable STAs. In an aspect, NSS^{const} may be an average NSSᵢ^{C} of all MU capable STAs (e,g, STA 206 and STA 208), (e.g., NSS^{const}=N̅S̅S̅ᵢ̅^̅{̅C̅}̅). In another aspect, NSS^{const} may be assigned the number of spatial streams, or NSSᵢ^{C}, of a representative MU capable STA so that all MU incapable STAs may have the same effective number of spatial streams NSSᵢ^{E} as the representative MU capable STA. Because NSS^{const} is a constant, NSSᵢ^{E} for MU incapable STAs may be independent of the number of spatial streams the MU incapable STAs support. In another aspect, NSS^{const} may be assigned to MU incapable STAs for purposes of calculating the scheduling metric to enable airtime fairness between MU incapable STAs and MU capable STAs.

Referring to Eq. 1, BWᵢ^{C} denotes a maximum bandwidth on which each STA i may operate, and Rᵢ^{TXOP} denotes a moving average TXOP consumption rate of each STA i. In an aspect, NSSᵢ^{E}·BWᵢ^{C} represents the effective spatial-time-frequency PHY capability of STA i. In an aspect, the effective spatial-time-frequency PHY capability of STA i may include Φᵢ to become Φᵢ NSSᵢ^{E}·BWᵢ^{C}. In an aspect, Rᵢ^{TXOP} may take into account the spatial, time, and frequency domain resource consumption. Eq. 1 compares the effective spatial-time-frequency PHY capability of STA i with the moving average of the actual rate of the spatial-time-frequency domain resources consumed by STA i to calculate the scheduling metric for STA i. Rᵢ^{TXOP} may be computed according to Eq. 3:

Rᵢ^{TXOP}=(1−δR)·R_{i,current}^{TWOP}+δ_{R}· [symbol] (Eq. 3)

Referring to Eq. 3, δ_{R} is a number between 0 and 1, R_{i,current}^{TXOP} denotes the TXOP consumption rate for STA i in the current scheduling instance, and [symbol] denotes the TXOP consumption rate for STA i in the last scheduling instance. δ_{R} is the weighting given to the TXOP consumption rate in the last scheduling instance and (1−δ_{R}) is the weighting given to the TXOP consumption rate in the current scheduling instance. δ_{R} may be small to give more weight to the TXOP consumption rate in the current scheduling instance when computing the moving average. The moving window may be the total length of time governed by the current scheduling instance and the last scheduling instance. In general, the moving average may average the TXOP consumption rate for more than two scheduling instances, with progressively larger weight given to more recent TXOP consumption rate. In an aspect, [symbol] may be computed according to Eq. 4:

$$= ( \frac{{NSS}_{i}}{{NSS}_{total}} ) \cdot ( \frac{{T}_{i}}{{T}_{MAX}} ) \cdot ( \frac{{BW}_{i}}{{BW}_{TOTAL}} ) \qquad ( Eq . 4 )$$

Referring to Eq. 4, NSSₜₒₜₐₗ denotes the total number of spatial streams the AP 202 uses on a particular MU or SU transmission that the STA i joins, and NSSᵢ denotes the number of spatial streams that the AP 202 gives to the STA i on the particular MU or SU transmission that the STA i joins. For an SU OFDMA transmission,

$$( \frac{{NSS}_{i}}{{NSS}_{total}} )$$

is equal to 1 because all the spatial streams of the AP 202 are assigned to the single user. In this example, references are made to the MU or SU transmission from the AP 202 that the STA i joins. In another aspect, references may be made to the MU or SU reception at the AP 202 of transmissions from the STAs that the STA i joins. Referring to Eq. 4, T_{MAX} denotes the allowed maximum TXOP in time, Tᵢ denotes the transmit time that STA i utilizes or joins for the TXOP. BW_{TOTAL} denotes the total bandwidth on which the AP 202 operates, and BWᵢ denotes the resource unit (RU) size, the frequency bands, or the number of subcarriers, assigned to the STA i for transmission during the TXOP. In an aspect, each RU may have a predetermined number of tones or subcarriers (e.g., 26 tones, 52 tones, 104 tones, etc.). In an aspect, for MU MIMO transmissions,

$$( \frac{{BW}_{i}}{{BW}_{TOTAL}} )$$

is equal to 1 if the MU MIMO transmission uses all subcarriers of the OFDM frequency band. In another example, the term [symbol] is equal to 0 if the STA i is not grouped for transmission in the last scheduling instance (e.g., not grouped for transmission in a physical layer convergence procedure (PLCP) protocol data unit (PPDU) transmission). Eq. 4 computes the consumption rate of the spatial-time-frequency domain resources by STA i in the last scheduling period. Eq. 4 may be used to similarly compute the consumption rate of the spatial-time-frequency domain resources by STA i in the current scheduling period.

Referring to FIG. 2, the AP 202 may determine a scheduling metric for each of the STAs 204, 206, 208. Although only three STAs are depicted in FIG. 2, the AP 202 may determine a scheduling metric for any number of STAs. The AP 202 may determine which STA among the group of STAs has the highest scheduling metric. A higher scheduling metric for a STA means that the effective spatial-time-frequency PHY capability of the STA was under-utilized in the last moving window. Conversely, a lower scheduling metric for a STA means that the effective spatial-time-frequency PHY capability of the STA was relatively more utilized in the last moving window. It may be desirable to schedule more airtime for the STA with the higher scheduling metric to allow the STA to more fully utilize its effective spatial-time-frequency PHY capability. In one aspect, it may be desirable to schedule the airtime for the plurality of STAs such that the resulting scheduling metrics for the STAs are the same or substantially the same, indicating fair scheduling. In one aspect, if there is a difference in the QoS requirements among the STAs, the spatial-time-frequency percentage target for a STA i with a higher QoS requirement, Φᵢ, may be adjusted upward to allow STA i to utilize more of its effective spatial-time-frequency PHY capability to meet the higher QoS requirement. Conversely, the AP 202 may determine from the data profile for a STA i that STA i does not need much airtime. The AP 202 may adjust downward the Φᵢ for STA i to allow STA i to utilize less of its effective spatial-time-frequency PHY capability.

The AP 202 may sort the scheduling metrics for all the STAs to determine the order by which airtime or TXOPs are assigned to the STAs. In one aspect, STAs associated with the higher scheduling metrics are assigned TXOPs first in descending priority until each STA has been assigned or the all the airtime have been assigned. For SU MIMO transmission, the AP 202 may schedule the STA with the highest scheduling metric for transmission. For example, if the STA 206 has the highest scheduling metric, then the AP 202 may transmit a message 210 to the STA 206. In one aspect, the message 210 may be a downlink packet with data for the STA 206. In another aspect, the message 210 may be a trigger frame indicating uplink resources on which the STA 206 may use for uplink transmission. For MU MIMO transmission, the AP 202 may identify STAs having the two highest scheduling metrics for transmission. For example, assuming the STAs 206, 208 are MU capable and have the two highest scheduling metrics, then the AP 202 may schedule STAs 206, 208 for MU MIMO transmission. For mixed SU-MU transmission, if MU incapable STA 204 and MU capable STA 206 have the two highest scheduling metrics, then AP 202 may schedule SU transmission to STA 204 and MU transmission to STA 206.

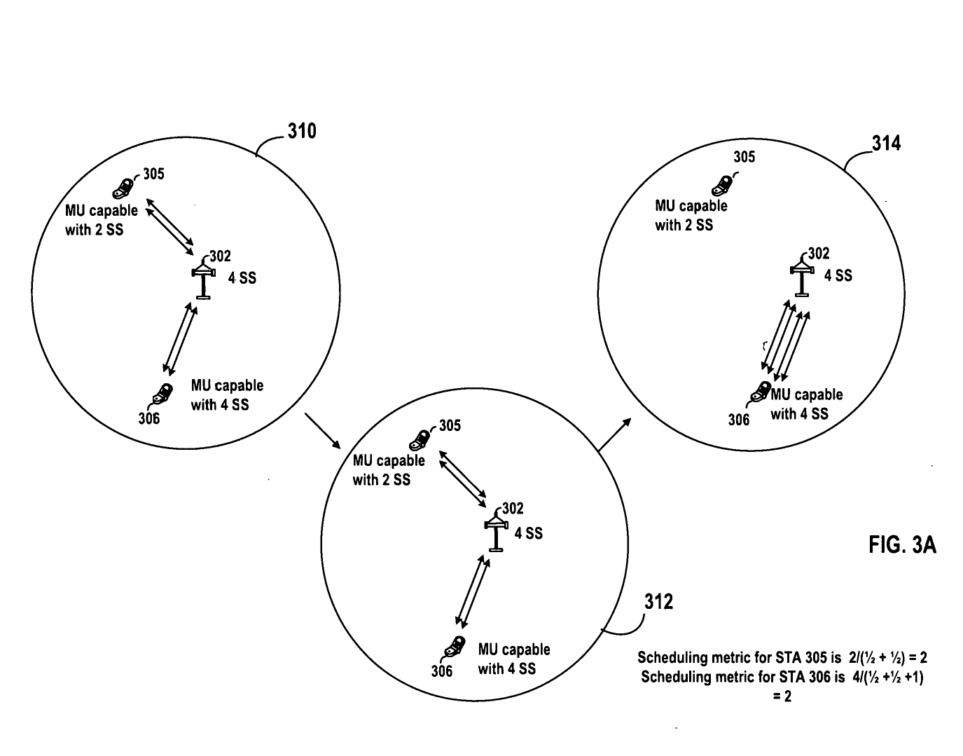

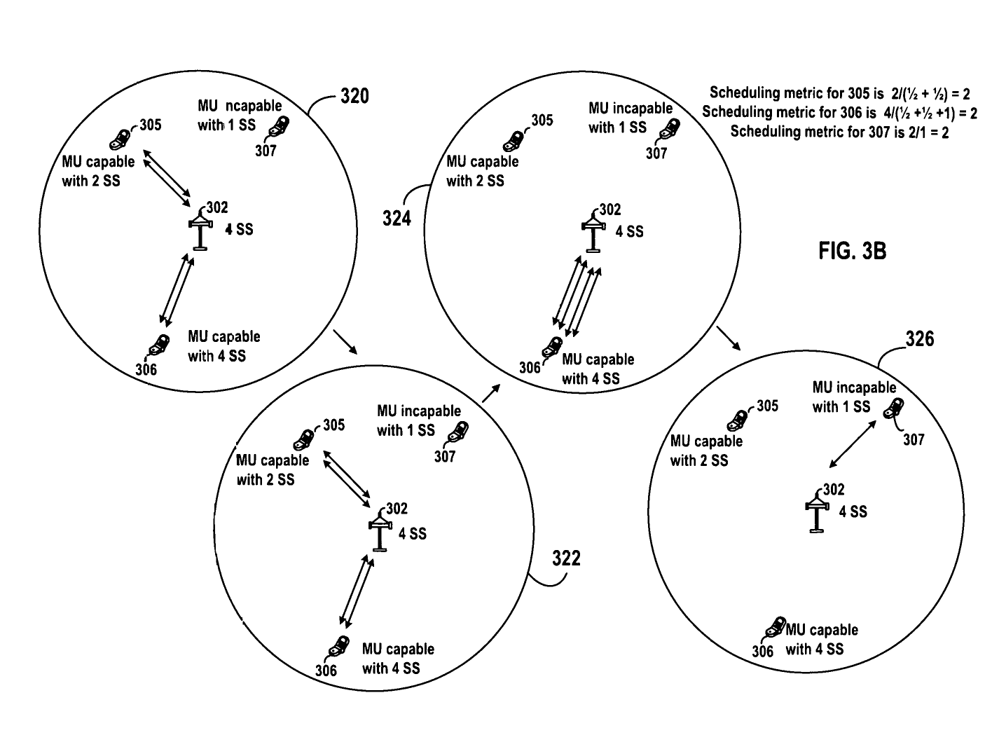

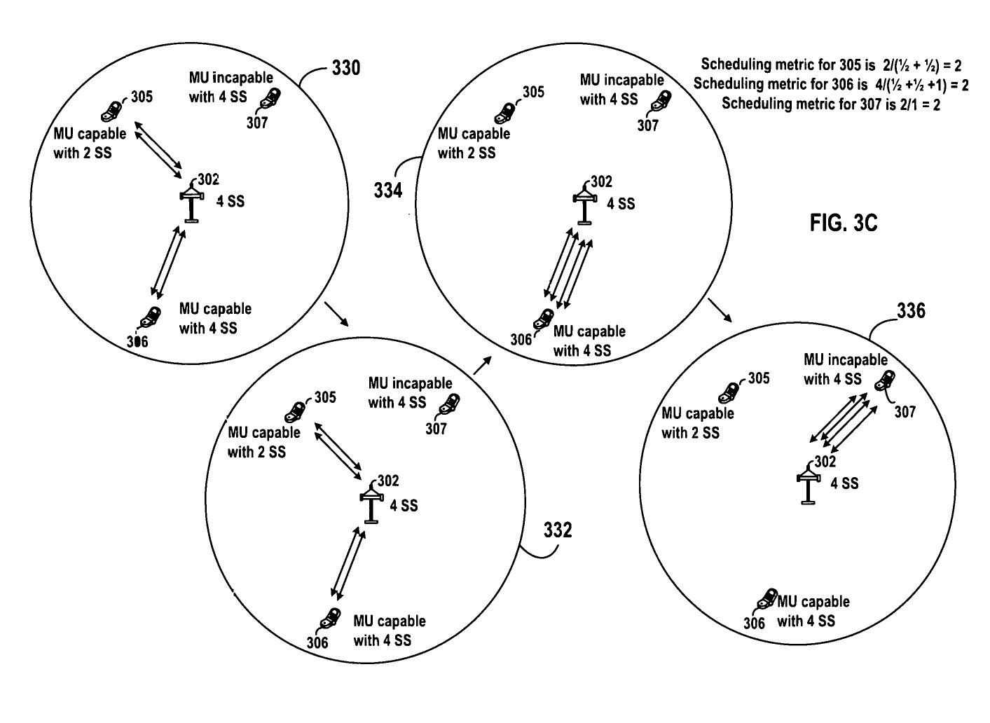

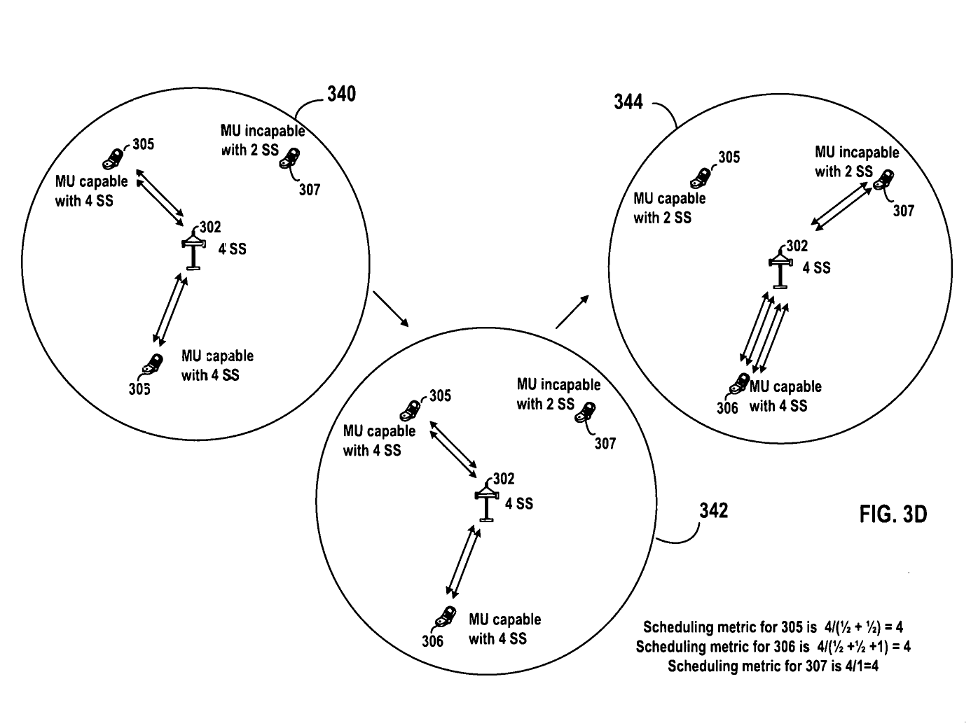

FIGS. 3A-3D are diagrams of four different setups for spatial-time fair scheduling among SU and MU capable STAs. Each diagram shows a series of scheduling instances or PPDUs for the allocation of spatial streams among the STAs. In FIG. 3A, in setup 1, an AP may support 4 spatial streams for transmission, STA 305 may be MU capable and may support 2 spatial streams for reception, and STA 306 may be MU capable and may support 4 spatial streams for reception. In PPDUs 310 and 312, STAs 305 and 306 may each be allocated 2 spatial streams among the 4 spatial streams (or half the number of spatial streams used) on which the AP transmits. Subsequently, in PPDU 314, STA 306 may be allocated all 4 spatial streams (or 100% of the spatial streams). Based on the foregoing, a scheduling metric for the STAs 305 and 306 may be computed as

$$\frac{{NSS}^{E}}{total fraction of spatial time} ,$$

where NSS^{E} denotes the effective number of spatial streams supported by the STA. For ease of discussion, assume the

$$( \frac{{BW}_{i}}{{BW}_{TOTAL}} )$$

is equal to 1 in Eq. 4 for the MU MIMO transmission. The NSS^{E} is 2 for STA 305 and NSS^{E} is 4 for STA 306. In setup 1, it is desired to have the scheduling metric for all STAs be equal. As calculated as under setup 1, the scheduling metric for STA 305 is equal to 2/(½+½)=2 because STA 305 is allocated half of the number of spatial streams used in PPDU 310 and PPDU 312. The scheduling metric for STA 306 is equal to 4/(½+½+1)=2 because STA 306 is allocated half of the number of spatial streams used in PPDU 310 and PPDU 312, and allocated all of the spatial streams used in PPDU 314. As such, the scheduling metrics for STA 305 and STA 306 are the same, indicating that the airtime has been allocated fairly between them. That is, while STA 306 can support twice the number of spatial streams as STA 305, STA 306 has also been allocated twice the number of airtime as STA 305.

In FIG. 3B, in setup 2, an AP may support 4 spatial streams for transmission, STA 305 may support 2 spatial streams for reception as in setup 1, STA 306 may support 4 spatial streams for reception as in setup 1, and STA 307 is MU incapable and may support 1 spatial stream for reception. In PPDUs 320 and 322, STAs 305 and 306 may each be allocated 2 spatial streams among the 4 spatial streams (or half the number of spatial streams used) on which the AP transmits. In PPDU 324, STA 306 may be allocated all 4 spatial streams (or 100% of the spatial streams). In PPDU 326, STA 307 may be allocated 1 spatial stream for SU transmission (100% of the spatial streams used because only one spatial stream is used in this transmission) because STA 307 supports 1 spatial stream. However, because STA 307 is MU incapable, the NSS^{E} of STA 307, for purposes of calculating the scheduling metric, may be set to NSS^{const} which in this case may be determined to be 2. Based on the foregoing, a scheduling metric for the STAs 305, 306, and 307 may be determined to be 2 as shown under setup 2.

In FIG. 3C, in setup 3, an AP may support 4 spatial streams for transmission, STA 305 may support 2 spatial streams for reception as in setup 1 and 2, STA 306 may support 4 spatial streams for reception as in setup 1 and 2, and STA 307 is MU incapable and may support 4 spatial stream for reception. In PPDUs 330 and 332, STAs 305 and 306 may each be allocated 2 spatial streams among the 4 spatial streams (or half the number of spatial streams used) on which the AP transmits. In PPDU 334, STA 306 may be allocated all 4 spatial streams (or 100% of the spatial streams). In PPDU 336, STA 307 may be allocated 4 spatial streams for SU transmission (100% of the spatial streams used for the transmission) because STA 307 supports 4 spatial streams. However, because STA 307 is MU incapable, the NSS^{E} of STA 307, for purposes of calculating the fairness metric, may be set to NSS^{const}, which in this case may be determined to be 2. Based on the foregoing, a fairness metric for the STAs 305, 306, and 307 may be determined to be 2 as shown under setup 3.

In FIG. 3D, in setup 4, an AP may support 4 spatial streams for transmission, STA 305 is MU capable and may support 4 spatial streams for reception, STA 306 is also MU capable and may support 4 spatial streams for reception, and STA 307 is MU incapable and may support 2 spatial stream for reception. In PPDUs 340 and 342, STAs 305 and 306 may each be allocated 2 spatial streams among the 4 spatial streams (or half the number of spatial streams used) on which the AP transmits. In PPDU 344, STA 307 may be allocated 2 spatial streams (or 100% of the spatial streams used) for SU transmission. However, because STA 307 is MU incapable, the NSS^{E} of STA 307, for purposes of calculating the fairness metric, may be set to NSS^{const}, which in this case may be determined to be 4. Based on the foregoing, a fairness metric for the STAs 305, 306, and 307 may be determined to be 4 as shown under setup 4.

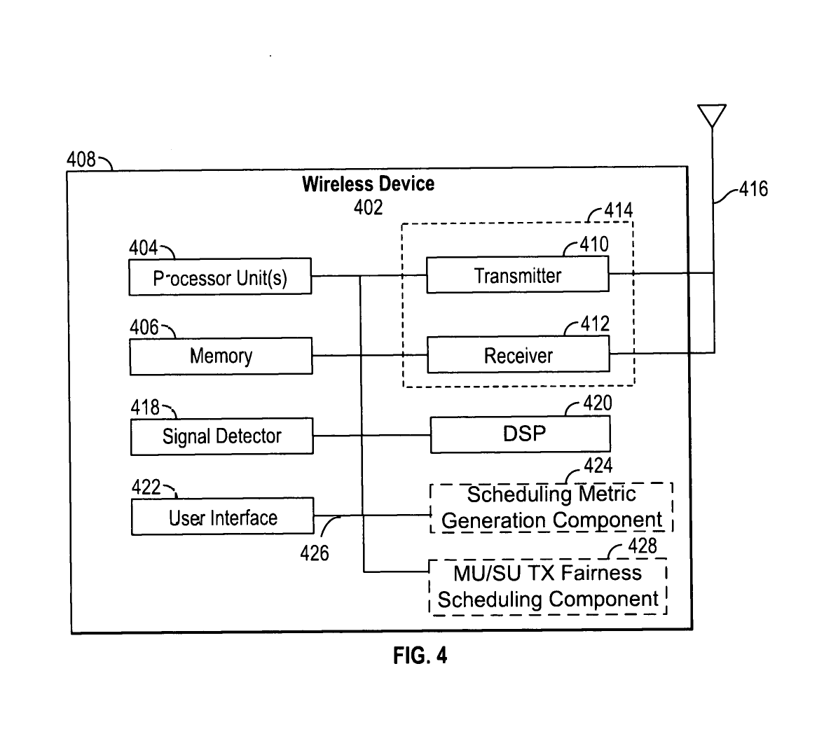

FIG. 4 shows an example functional block diagram of a wireless device 402 that determines spatial-time scheduling for SU and MU transmissions within the wireless communication system 100 of FIG. 1. The wireless device 402 is an example of a device that may be configured to implement the various methods described herein. For example, the wireless device 402 may comprise an AP (e.g., the AP 104) or a STA (e.g., the STA 114). The AP may determine spatial-time scheduling for transmissions from the AP to MU capable and MU incapable STAs. In one aspect, the AP may determine spatial-time scheduling for transmissions from the MU capable and MU incapable STAs to the AP.

The wireless device 402 may include a processor 404 which controls operation of the wireless device 402. The processor 404 may also be referred to as a central processing unit (CPU). Memory 406, which may include both read-only memory (ROM) and random access memory (RAM), may provide instructions and data to the processor 404. A portion of the memory 406 may also include non-volatile random access memory (NVRAM). The processor 404 typically performs logical and arithmetic operations based on program instructions stored within the memory 406. The instructions in the memory 406 may be executable (by the processor 404, for example) to implement the methods described herein.

The processor 404 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 402 may also include a housing 408, and the wireless device 402 may include a transmitter 410 and/or a receiver 412 to allow transmission and reception of data between the wireless device 402 and a remote device. The transmitter 410 and the receiver 412 may be combined into a transceiver 414. An antenna 416 may be attached to the housing 408 and electrically coupled to the transceiver 414. The wireless device 402 may also include multiple transmitters, multiple receivers, multiple transceivers, and/or multiple antennas to implement MIMO.

The wireless device 402 may also include a signal detector 418 that may be used to detect and quantify the level of signals received by the transceiver 414 or the receiver 412. The signal detector 418 may detect such signals as total energy, energy per subcarrier per symbol, power spectral density, and other signals. The wireless device 402 may also include a DSP 420 for use in processing signals. The DSP 420 may be configured to generate a packet for transmission. In some aspects, the packet may comprise a PPDU

The wireless device 402 may further comprise a user interface 422 in some aspects. The user interface 422 may comprise a keypad, a microphone, a speaker, and/or a display. The user interface 422 may include any element or component that conveys information to a user of the wireless device 402 and/or receives input from the user.

The wireless device 402 may also comprise a scheduling metric generation component 424 and a MU/SU TX fairness scheduling component 428. The scheduling metric generation component 424 may be configured to determine a scheduling metric to perform procedures related to spatial-time scheduling for each station of a plurality of stations. The scheduling metric for a station may be based on a target percentage of spatial-time resources allocated for the station, an effective number of spatial streams supported by the station, a maximum bandwidth, and a TXOP moving average consumption rate of the station. The MU/SU TX fairness scheduling component 428 may be configured to schedule each station of the plurality of stations for communication based on the determined scheduling metric for each station. In an aspect, the target percentage of spatial-time resources allocated for the station may correspond to a percentage of a total number of spatial streams and timed data units such as PPDUs assigned to the station. In one aspect, the target percentage of spatial-time resources allocated for the station may include spectral resources such as frequency channels or subcarriers allocated for the station.

In one configuration, the scheduling metric generation component 424 may be configured to determine the scheduling metric by determining whether a station is MU capable and by determining the effective number of spatial streams for the station based on whether the station is MU capable. In another aspect, the effective number of spatial streams for a MU capable station may correspond to a maximum number of spatial streams supported by the station. The effective number of spatial streams supported by the STA may take into account the PHY capability such as the transmit/receive (TX/RX) capability of the station under its current channel condition. In another aspect, the effective number of spatial streams for a MU incapable station may correspond to an average of the effective number of spatial streams supported by MU capable stations within the plurality of stations. In another configuration, the scheduling metric generation component 424 may be configured to determine the scheduling metric by determining a maximum bandwidth on which each station of the plurality of stations operates.

In another configuration, the scheduling metric generation component 424 may be configured to determine the scheduling metric for a station by computing the TXOP moving average consumption rate for the station. The TXOP moving average consumption rate for the station may be based on at least one of a ratio of spatial stream usage, a ratio of transmit time usage, or a ratio of bandwidth usage consumed by the station in a moving window of interest. In another configuration, the scheduling metric generation component 424 may be configured to determine the TXOP moving average consumption rate by calculating a product of the spatial stream usage ratio, the transmit time usage ratio, and the bandwidth usage ratio. The MU/SU TX fairness scheduling component 428 may be configured to sort the scheduling metrics for all the stations to determine the order by which TXOPs are assigned to the stations. The TXOP for a station contains the spatial-timing-frequency resources to be used by the station for communicating with the wireless device 402. The TXOP for a station may be assigned for communication from the wireless device 402 to the station, and/or communication from the station to the wireless device 402. At periodic intervals, the wireless device 402 may recompute the TXOP moving average consumption rate and the scheduling metric for each station to reassign the TXOPs among the stations based on changing traffic profiles and channel conditions.

The various components of the wireless device 402 may be coupled together by a bus system 426. The bus system 426 may include a data bus, for example, as well as a power bus, a control signal bus, and a status signal bus in addition to the data bus. Components of the wireless device 402 may be coupled together or accept or provide inputs to each other using some other mechanism.

Although a number of separate components are illustrated in FIG. 4, one or more of the components may be combined or commonly implemented. For example, the processor 404 may be used to implement not only the functionality described above with respect to the processor 404, but also to implement the functionality described above with respect to the signal detector 418, the DSP 420, the user interface 422, the scheduling metric generation component 424, and/or the MU/SU TX fairness scheduling component 428. Further, each of the components illustrated in FIG. 4 may be implemented using a plurality of separate elements.

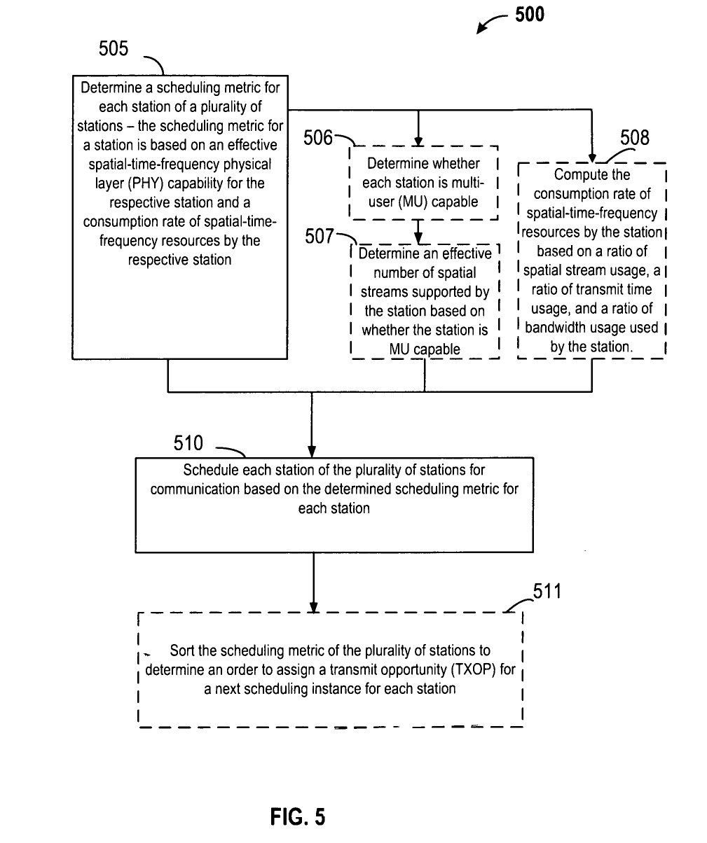

FIG. 5 is a flowchart of an example method 500 of scheduling stations based on a scheduling metric. The method 500 may be performed using an apparatus (e.g., the AP 104, the STA 114, or the wireless device 402, for example). Although the method 500 is described below with respect to the elements of wireless device 402 of FIG. 4, other components may be used to implement one or more of the steps described herein. The dotted lines in FIG. 5 may indicate optional operations.

At block 505, the apparatus may determine a scheduling metric for each station of a plurality of stations. The scheduling metric for a station may be based on an effective spatial-time-frequency physical layer (PHY) capability for the respective station and a consumption rate of spatial-time-frequency resources by the respective station. For example, referring to FIG. 2, the apparatus may be the AP 202. The AP 202 may determine a scheduling metric for each of the STAs 204, 206, 208 according to Eq. 1.

In one aspect, at block 506, the apparatus may determine whether a station is MU capable. At block 507, the apparatus may determine the effective number of spatial streams supported by the station based on whether the station is MU capable. For example, if the station is MU capable, the effective number of spatial streams supported by the station may correspond to a maximum number of spatial streams supported by the MU capable station. On the other hand, if the station is not MU capable, the effective number of spatial streams supported by the station may correspond to an average of the effective number of spatial streams supported by stations that are MU capable.

In one aspect, at block 508, the apparatus may compute the consumption rate of spatial-time-frequency resources by a station based on a ratio of spatial stream usage, a ratio of transmit time usage, and a ratio of bandwidth usage by the station. In one aspect, the consumption rate of spatial-time-frequency resources by a station may be a TXOP moving average of consumption rate by the station. For example, the apparatus may compute the TXOP moving average of consumption rate for a station by calculating the product of the ratio of spatial stream usage, the ratio of transmit time usage, and the ratio of bandwidth usage by the station.

At block 510, the apparatus may schedule each station of the plurality of stations for communication based on the determined scheduling metric for each station. In one aspect, at 511, the apparatus may sort the scheduling metrics for all the stations to determine the order by which TXOPs are assigned to the stations for the next scheduling instance. For example, referring to FIG. 2, the AP 202 may schedule the TXOPs for each of the STAs 204, 206, 208 based on the type of transmission (SU or MU) and based on the scheduling metric of each STA. For SU MIMO transmission, the AP 202 may select the STA with the highest scheduling metric for SU transmission. For MU MIMO transmission, the AP 202 may select the STAs with the two highest scheduling metrics for MU MIMO transmission. For mixed SU-MU transmission, the AP 202 may select the STAs starting from the highest to the lowest scheduling metric in descending order until each STA has received its scheduled TXOP or until all the TXOPs have been assigned. In an aspect, if the AP 202 is scheduling STAs for uplink transmission, the AP 202 may transmit the message 210, which may be a trigger frame, to the STAs (e.g., the STA 206) scheduled for transmission. In this aspect, the message 210 may be transmitted based on the determined scheduling metric.

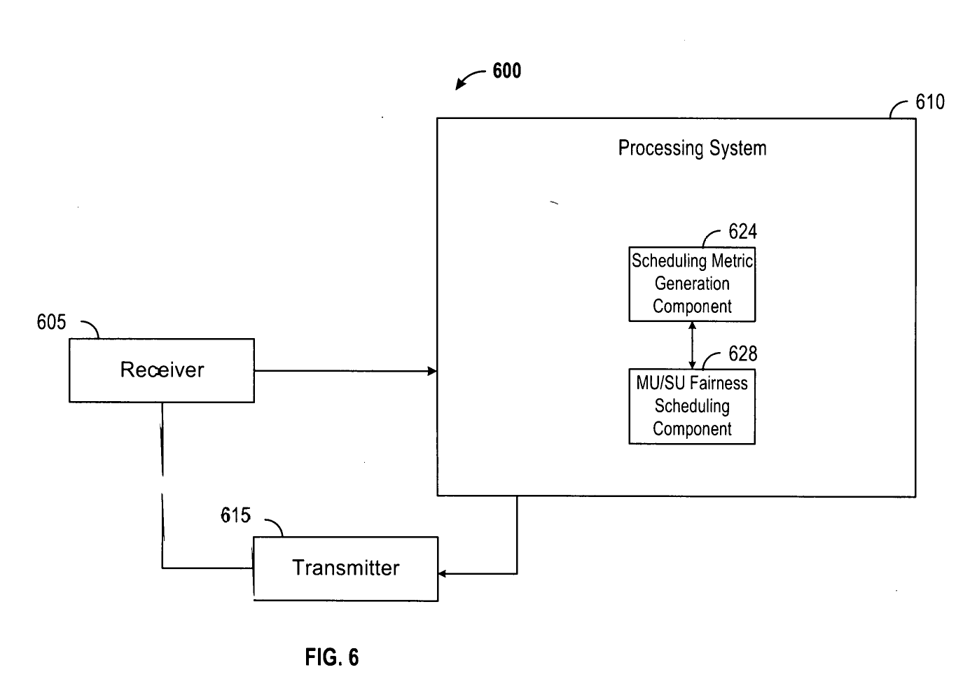

FIG. 6 is a functional block diagram of an example wireless communication device 600 that may determine a scheduling metric based on PHY capabilities. The wireless communication device 600 may include a receiver 605, a processing system 610, and a transmitter 615. The processing system 610 may include a scheduling metric generation component 624 and a MU/SU fairness scheduling component 628. The processing system 610 and/or the scheduling metric generation component 624 may be configured to determine a scheduling metric for each station of a plurality of stations. The scheduling metric for a station may be based on a target percentage of spatial-time resources allocated for the station, an effective number of spatial streams supported by the station, a maximum bandwidth to be operated by the station, and a TXOP moving average consumption rate of the station. The processing system 610 and/or the MU/SU fairness scheduling component 628 may be configured to schedule each station of the plurality of stations for communication based on the determined scheduling metric for each station. In an aspect, the target percentage of spatial-time resources allocated for a station may correspond to a percentage of a total number of spatial streams and timed data units such as PPDUs assigned to the station. In one aspect, the target percentage of spatial-time resources allocated for the station may include spectral resources such as frequency channels or subcarriers allocated for the station.

In one configuration, the processing system 610 and/or the scheduling metric generation component 624 may be configured to determine the scheduling metric by determining whether a station is MU capable and by determining the effective number of spatial streams for the station based on whether the station is MU capable. In another aspect, the effective number of spatial streams for a MU capable station may correspond to a maximum number of spatial streams supported by the station. The effective number of spatial streams supported by the STA may take into account the PHY capability such as the transmit/receive (TX/RX) capability of the station under its current channel condition. In another aspect, the effective number of spatial for a MU incapable station may correspond to an average of the effective number of spatial streams supported by MU capable stations within the plurality of stations. In another configuration, the processing system 610 and/or the scheduling metric generation component 624 may be configured to determine the scheduling metric by determining a maximum bandwidth on which each station of the plurality of stations operates.

In another configuration, the scheduling metric generation component 624 may be configured to determine the scheduling metric for a station by computing the TXOP moving average consumption rate for the station. The TXOP moving average consumption rate for the station may be based on at least one of a ratio of spatial stream usage, a ratio of transmit time usage, or a ratio of bandwidth usage consumed by the station in a moving window of interest. In another configuration, the processing system 610 and/or the scheduling metric generation component 624 may be configured to determine the TXOP moving average consumption rate by calculating a product of the spatial stream usage ratio, the transmit time usage ratio, and the bandwidth usage ratio.

In one configuration, the processing system 610 and/or the MU/SU fairness scheduling component 628 may be configured to sort the scheduling metrics for all the stations to determine the order by which TXOPs are assigned to the stations. The TXOP for a station contains the spatial-timing-frequency resources to be used by the station for communicating with the wireless communication device 600. The TXOP for a station may be assigned for communication from the wireless communication device 600 to the station, and/or communication from the station to the wireless communication device 600. At periodic intervals, the processing system 610 and/or the scheduling metric generation component 624 may recompute the TXOP moving average consumption rate and the scheduling metric for each station to reassign the TXOPs among the stations based on changing traffic profiles and channel conditions.

The receiver 605, the processing system 610, the scheduling metric generation component 624, the MU/SU fairness scheduling component 628, and/or the transmitter 615 may be configured to perform one or more functions discussed above with respect to blocks 505, 506, 507, 508, 510, and 511 of FIG. 5. The receiver 605 may correspond to the receiver 412. The processing system 610 may correspond to the processor 404. The transmitter 615 may correspond to the transmitter 410. The scheduling metric generation component 624 may correspond to the scheduling metric generation component 124 and/or the scheduling metric generation component 424. The MU/SU fairness scheduling component 628 may correspond to the MU/SU fairness scheduling component 125 and/or the MU/SU fairness scheduling component 428.

In one configuration, the wireless communication device 600 may include means for determining a scheduling metric for each station of a plurality of stations. The scheduling metric for a station may be based on a target percentage of spatial-time resources allocated for the station, an effective number of spatial streams supported by the station, a maximum bandwidth to be operated by the station, and a TXOP moving average consumption rate of the station. The wireless communication device 600 may include means for scheduling each station of the plurality of stations for communication based on the determined scheduling metric for each station. In an aspect, the target percentage of spatial-time resources allocated for a station may correspond to a percentage of a total number of spatial streams timed data units such as PPDUs assigned to the station. In one aspect, the target percentage of spatial-time resources allocated for the station may include spectral resources such as frequency channels or subcarriers allocated for the station.

In one configuration, the means for determining the scheduling metric may be configured to determine whether a station is MU capable and to determine the effective number of spatial streams for the station based on whether the station is MU capable. In another aspect, the effective number of spatial streams for a MU capable station may correspond to a maximum number of spatial streams supported by the station. The effective number of spatial streams supported by the station may take into account the PHY capability such as the transmit/receive (TX/RX) capability of the station under its current channel condition. In another aspect, the effective number of spatial streams for a MU incapable station may correspond to an average of the effective number of spatial streams supported by MU capable stations within the plurality of stations. In another configuration, the means for determining the scheduling metric may be configured to determine a maximum bandwidth on which each station of the plurality of stations operates.

In another configuration, the means for determining the scheduling metric may be configured to compute the TXOP moving average consumption rate for a station. The TXOP moving average consumption rate for the station may be based on at least one of a ratio of spatial stream usage, a ratio of transmit time usage, or a ratio of bandwidth usage consumed by the station in a moving window of interest. In another configuration, the means for determining the TXOP moving average may be configured to calculate a product of the spatial stream usage ratio, the transmit time usage ratio, and the bandwidth usage ratio.

In one configuration, the wireless communication device 600 may include means for determining MU/SU fairness scheduling. In one configuration, the means for determining MU/SU fairness scheduling may be configured to sort the scheduling metrics for all the stations to determine the order by which TXOPs are assigned to the stations. The TXOP for a station contains the spatial-timing-frequency resources to be used by the station for communicating with the wireless communication device 600. The means for determining the scheduling metric may be configured to assign The TXOP for a station for communication from the wireless communication device 600 to the station, and/or communication from the station to the wireless communication device 600. At periodic intervals, the means for determining the scheduling metric may be configured to recompute the TXOP moving average consumption rate and the scheduling metric for each station to reassign the TXOPs among the stations based on changing traffic profiles and channel conditions.

In one configuration, the means for determining the scheduling metric may include the processing system 610 and/or the scheduling metric generation component 624. In one configuration, the means for determining MU/SU fairness scheduling may include the processing system 610 and/or the MU/SU fairness scheduling component 628. In another configuration, the means for determining the scheduling metric may include the processing system 610, the scheduling metric generation component 624, the MU/SU fairness scheduling component 628, and/or the transmitter 615.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an application specific integrated circuit (ASIC), an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

What is claimed is:

1. A method of wireless communication, comprising:
determining a scheduling metric for each respective station of a plurality of stations, the scheduling metric for each respective station of the plurality of stations being based on an effective spatial-time-frequency physical layer (PHY) capability for the respective station and a consumption rate of spatial-time-frequency resources by the respective station; and
scheduling each respective station of the plurality of stations for communication based on the determined scheduling metric for each respective station.

2. The method of claim 1, wherein the scheduling metric for each respective station of the plurality of stations is based on a ratio of the effective spatial-time-frequency PHY capability for the respective station and the consumption rate of spatial-time-frequency resources by the respective station.

3. The method of claim 1, wherein the effective spatial-time-frequency PHY capability for the respective station is a product of a target percentage of spatial-time resources allocated to the respective station, an effective number of spatial streams supported by the respective station, and a maximum bandwidth, and wherein the consumption rate of spatial-time-frequency resources by the respective station is a transmit opportunity (TXOP) moving average of consumption rate by the respective station.

4. The method of claim 3, wherein the target percentage of spatial-time resources allocated to the respective station corresponds to at least one of a percentage of a total number of spatial streams assigned to the respective station and a percentage of a total number of timed data units assigned to the respective station.

5. The method of claim 3, wherein the target percentage of spatial-time resources allocated to the respective station corresponds to a percentage of a total number of spectral resources assigned to the respective station.

6. The method of claim 3, wherein determining the scheduling metric comprises:
determining whether each respective station of the plurality of stations is multi-user (MU) capable; and
determining the effective number of spatial streams supported by the respective station based on whether the respective station is MU capable.

7. The method of claim 6, wherein the effective number of spatial streams supported by the respective station corresponds to a maximum number of spatial streams supported by the respective station if the respective station is MU capable.

8. The method of claim 7, wherein the effective number of spatial streams supported by the respective station is affected by a PHY capability of the respective station under a current channel condition.

9. The method of claim 6, wherein if the respective station is MU incapable, the effective number of spatial streams supported by the respective station corresponds to an average of the effective number of spatial streams supported by MU capable stations within the plurality of stations.

10. The method of claim 3, wherein determining the scheduling metric comprises:
determining a maximum bandwidth on which each respective station of the plurality of stations operates.

11. The method of claim 3, wherein determining the scheduling metric comprises:
computing the TXOP moving average of consumption rate by the respective station, wherein the TXOP moving average of consumption rate is based on at least one of a ratio of spatial stream usage, a ratio of transmit time usage, and a ratio of bandwidth usage.

12. The method of claim 11, wherein computing the TXOP moving average of consumption rate by the respective station comprises:
calculating a product of the ratio of spatial stream usage, the ratio of transmit time usage, and the ratio of bandwidth usage.

13. The method of claim 11, wherein computing the TXOP moving average of consumption rate by the respective station comprises:
computing the TXOP consumption rate for a last scheduling instance;
computing the TXOP consumption rate for a current scheduling instance; and
computing a weighted sum of the TXOP consumption rate for the last scheduling instance and the TXOP consumption rate for the current scheduling instance.

14. The method of claim 1, wherein scheduling each respective station comprises:
sorting the determined scheduling metric for each respective station of the plurality of stations to determine an order to assign a transmit opportunity (TXOP) for a next scheduling instance for each respective station.

15. The method of claim 14, wherein scheduling each respective station further comprises:
assigning the TXOP for the next scheduling instance for each respective station starting from a first station of the plurality of stations associated with a highest scheduling metric to a second station of the plurality of stations associated with a lowest scheduling metric in descending order.

16. An apparatus for wireless communication, comprising:
a memory; and
at least one processor coupled to the memory and configured to:
determine a scheduling metric for each respective station of a plurality of stations, the scheduling metric for each respective station of the plurality of stations being based on an effective spatial-time-frequency physical layer (PHY) capability for the respective station and a consumption rate of spatial-time-frequency resources by the respective station; and
schedule each respective station of the plurality of stations for communication based on the determined scheduling metric for each respective station.

17. The apparatus of claim 16, wherein the scheduling metric for each respective station of the plurality of stations is based on a ratio of the effective spatial-time-frequency PHY capability for the respective station and the consumption rate of spatial-time-frequency resources by the respective station.

18. The apparatus of claim 16, wherein the effective spatial-time-frequency PHY capability for the respective station is a product of a target percentage of spatial-time resources allocated to the respective station, an effective number of spatial streams supported by the respective station, and a maximum bandwidth, and wherein the consumption rate of spatial-time-frequency resources by the respective station is a transmit opportunity (TXOP) moving average of consumption rate by the respective station.

19. The apparatus of claim 18, wherein the target percentage of spatial-time resources allocated to the respective station corresponds to at least one of a percentage of a total number of spatial streams assigned to the respective station and a percentage of a total number of timed data units assigned to the respective station.

20. The apparatus of claim 1R, wherein the target percentage of spatial-time resources allocated to the respective station corresponds to a percentage of a total number of spectral resources assigned to the respective station.

21. The apparatus of claim 19, wherein the at least one processor is further configured to:
determine whether each respective station of the plurality of stations is multi-user (MU) capable; and
determine the effective number of spatial streams supported by the respective station based on whether the respective station is MU capable.

22. The apparatus of claim 21, wherein the effective number of spatial streams supported by the respective station corresponds to a maximum number of spatial streams supported by the respective station if the respective station is MU capable.

23. The apparatus of claim 22, wherein the effective number of spatial streams supported by the respective station is affected by a PHY capability of the respective station under a current channel condition.

24. The apparatus of claim 21, wherein if the respective station is MU incapable, the effective number of spatial streams supported by the respective station corresponds to an average of the effective number of spatial streams supported by MU capable stations within the plurality of stations.

25. The apparatus of claim 18, wherein the at least one processor is further configured to determine a maximum bandwidth on which each respective station of the plurality of stations operates.

26. The apparatus of claim 18, wherein the at least one processor is further configured to:
compute the TXOP moving average of consumption rare by the respective station, wherein the TXOP moving average of consumption rate is based on at least one of a ratio of spatial stream usage, a ratio of transmit time usage, and a ratio of bandwidth usage.

27. The apparatus of claim 26, wherein the at least one processor is further configured to calculate a product of the ratio of spatial stream usage, the ratio of transmit time usage, and the ratio of bandwidth usage.

28. The apparatus of claim 16, wherein the at least one processor is further configured to sort the determined scheduling metric for each respective station of the plurality of stations to determine an order to assign a transmit opportunity (TXOP) for a next scheduling instance for each respective station.

29. An apparatus for wireless communication, comprising:
means for determining a scheduling metric for each respective station of a plurality of stations, the scheduling metric for each respective station of the plurality of stations being based on an effective spatial-time-frequency physical layer (PHY) capability for the respective station and a consumption rate of spatial-time-frequency resources by the respective station; and
means for scheduling each respective station of the plurality of stations for communication based on the determined scheduling metric for each respective station.

30. A non-transitory computer-readable medium storing computer executable code, comprising code to:
determine a scheduling metric for each respective station of a plurality of stations, the scheduling metric for each respective station of the plurality of stations being based on an effective spatial-time-frequency physical layer (PHY) capability for the respective station and a consumption rate of spatial-time-frequency resources by the respective station; and
schedule each respective station of the plurality of stations for communication based on the determined scheduling metric for each respective station.
